(19) United States
(12) Patent Application Publication
(10) Pub. No.: US 2005/0207481 A1
(43) Pub. Date: Sep. 22, 2005

(54) Transmit/receive filter and method for manufacturing same

(75) Inventor: Hans Peter Forstner, Steinhoering (DE)

Correspondence Address: Maginot, Moore & Beck;Bank One Tower, Suite 3000, 111 Monument Circle, Indianapolis, IN, 46204, US

(73) Assignee: Infineon Technologies AG, Munchen (DE)

(21) Appl. No.: 11/071,562

(22) Filed: Mar. 3, 2005

(30) Foreign Application Priority Data
Mar. 3, 2004 (DE) 102004010396.8-35

(51) Int. Cl. H04B 1/38

(52) U.S. Cl. 375/219

(57) ABSTRACT

A transmit/receive filter includes a substrate, an antenna terminal, a transmit filter assembly arranged on a first substrate portion, an output of the transmit filter assembly being connected to the antenna terminal, a receive filter assembly arranged on a second substrate portion, and a discrete phase shifter arranged on a third substrate portion, the discrete phase shifter being formed of discrete circuit elements and an input of the receive filter assembly being connected to the antenna terminal via the discrete phase shifter, the discrete phase shifter being formed to set a predetermined phase relation to decouple the receive filter assembly from the transmit filter assembly.

### CROSS-REFERENCE TO RELATED APPLICATION

This application claims priority from German Patent Application No. 10 2004 010 396.8, which was filed on Mar. 3, 2004, and is incorporated herein by reference in its entirety.

### BACKGROUND OF THE INVENTION

1. Field of the Invention

The present invention relates to transmit/receive filter structures formed on a substrate.

2. Description of the Related Art

Transmit/receive filters, which are also referred to as duplex filters, are 3-port elements connecting two system blocks, such as, for example, a transmitter and a receiver, to a common port (e.g. an antenna). Such filters are, for example, required for transceivers, i.e. for transmit/receive structures, which can transmit and receive simultaneously. Such systems are also referred to as full duplex systems.

In order to ensure undisturbed coexistence of transmitter and receiver, it is necessary for the duplex filter to be frequency-selective to insulate the two branches, i.e. a transmit branch and a receive branch, from each other in the best way possible. Additionally, over-coupling of transmit signals to the receiver or the receive filter should be suppressed. Circulators, for example, can be used for this. It is a disadvantage of this approach that circulators are expensive and can only be used with higher transmit or receive frequencies. In modern mobile radio systems, however, the frequency band is 5 to 6 GHz.

FIG. 9 is a block diagram of a duplex filter according to the prior art. The duplex filter includes a transmit filter 901, a receive filter 903 and a line transformer 905 which is, for example, formed as a strip line.

The receive filter should be decoupled from the transmit filter to ensure that, for example, the transmit signals passing the transmitter chip (TX chip) are not attenuated by the receive filter (receive chip, RX chip). This can generally be obtained by means of an all-pass. Additional inductivities are, however, usually required here to adjust the filter characteristic to the system requirements. In well-known systems, the filter chips each comprising a transmit filter and a receive filter are deposited on a multi-layered substrate which can, for example, be made of a ceramic or organic materials. On or in the substrate (carrier), the all-pass, such as, for example, in an intermediate layer, and diverse inductivities are realized as strip-line elements.

It is a disadvantage of the approach described above that strip lines formed as λ/4 line transformers are used for decoupling the receive filter and the transmit filter. In the frequency range mentioned above, such strip-line transformers, however, have considerable lengths up to 20 mm and more so that an efficient element miniaturization is no longer possible. To accommodate such a strip line the substrates are, as has already been mentioned, formed in several layers so that the strip line is arranged in one of the intermediate layers.

### SUMMARY OF THE INVENTION

It is the object of the present invention to provide an efficient concept for a transmit/receive filter.

In accordance with a first aspect, the present invention provides a transmit/receive filter having a substrate, an antenna terminal and a transmit filter assembly arranged on a first substrate portion of the substrate, an output of the transmit filter assembly being connected to the antenna terminal. The inventive transmit/receive filter structure additionally includes a receive filter assembly arranged on a second substrate portion and a discrete phase shifter arranged on a third substrate portion, the discrete phase shifter being formed of discrete circuit elements. An input of the receive filter assembly is connected to the antenna terminal via the discrete phase shifter. The discrete phase shifter is formed to set a predetermined phase shift to decouple the receive filter assembly from the transmit filter assembly.

In accordance with a second aspect, the present invention provides a method for manufacturing a transmit/receive filter, having the steps of: providing a substrate; providing a transmit filter assembly; providing a receive filter assembly; providing a discrete phase shifter; providing an antenna terminal; arranging the transmit filter assembly on a first substrate portion; arranging the receive filter assembly on a second substrate portion; arranging the discrete phase shifter on a third substrate portion; connecting an output of the transmit filter assembly to the antenna terminal; and connecting an input of the receive filter assembly to the antenna terminal via the discrete phase shifter to decouple the receive filter assembly from the transmit filter assembly.

The present invention is based on the finding that an efficient transmit/receive filter can be realized by realizing a decoupling of the receive filter structure and the transmit filter structure by means of a discrete phase shifter having discrete circuit elements, wherein the discrete phase shifter can, for example, be formed on an additional chip.

It is possible by means of the inventive concept to replace the multi-layered carrier material entailing the problems mentioned above by a single-layered substrate or by a simple MMIC package (MMIC=monolithic microwave integrated circuit). A passive chip comprising the discrete phase shifter can, for example, be arranged on the single-layered substrate. Size and cost advantages result from this. Furthermore, the high-frequency characteristics of the transmit and/or receive filter assemblies can inventively be influenced and improved selectively by associating ground islands. Small metallization losses and a small implementation complexity additionally result when manufacturing the inventive transmit/receive filter. Due to the reduced size, the inventive transmit/receive filters can be integrated into complex systems on the basis of a multi-chip mounting, the result being further cost advantages compared to other structures. In addition, the inventive transmit/receive filter comprises good thermal characteristics since the chips having the three elements of a transmit filter assembly, a receive filter assembly and a discrete phase shifter can, for example, be arranged on separate substrate portions spaced apart from one another. Since the inventive transmit/receive filter can be housed easily, the manufacturing and implementation complexity can additionally be reduced.

### BRIEF DESCRIPTION OF THE DRAWINGS

Further embodiments of the present invention will be detailed subsequently referring to the appended drawings, in which:

FIG. 1 shows a block diagram of a transmit/receive filter according to a first embodiment of the present invention;

FIG. 2 shows a block diagram of an inventive transmit/receive filter according to another embodiment of the present invention;

FIG. 3 shows the performance of the inventive transmit/receive filter in a comparison;

FIG. 4 shows the performance of the inventive transmit/receive filter in a comparison;

FIG. 5 shows a measurement setup;

FIG. 6 shows the performance of the inventive transmit/receive filter in a comparison;

FIG. 7 shows characteristics measured of the inventive transmit/receive filter;

FIG. 8 shows the setup and characteristics of an inventive discrete phase shifter according to another embodiment of the present invention; and

FIG. 9 shows a block circuit diagram of a prior art duplex filter.

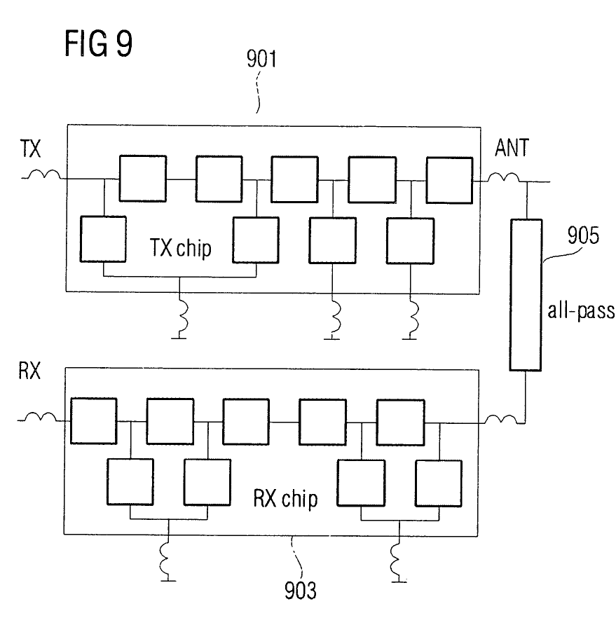

### DESCRIPTION OF THE PREFERRED EMBODIMENTS

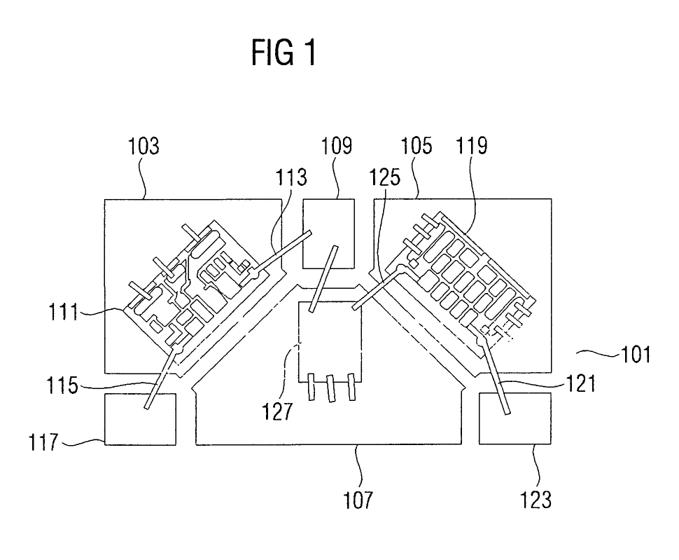

FIG. 1 shows a transmit/receive filter according to a first embodiment of the present invention. The transmit/receive filter includes a substrate 101 having a first substrate portion 103, a second substrate portion 105 and a third substrate portion 107. As is indicated in FIG. 1, the first substrate portion 103, the second substrate portion 105 and the third substrate portion 107 are spaced apart from one another so that the substrate 101 consists of several substrate portions spaced apart from one another. The substrate 101 can, however, be continuous so that the first substrate portion 103, the second substrate portion 105 and the third substrate portion 107 are portions of a continuous substrate or of a continuous substrate layer. Preferably, the substrate 101 is formed as a single-layered substrate. This means that the substrate 101, in a vertical direction, consists of one substrate layer. The substrate 101, however, may, in a vertical direction, comprise another substrate layer on or in which connection lines are arranged.

Additionally, the transmit/receive filter includes an antenna terminal 109 and a transmit filter assembly 111 arranged on the first substrate portion 103. Here, an output 113 of the transmit filter assembly 111 is connected to the antenna terminal 109. An input 115 is connected to a terminal 117.

Furthermore, the transmit/receive filter comprises a receive filter assembly 119 arranged on the second substrate portion 105, having an input 121 coupled to a terminal 123. In addition, the receive filter assembly 119 includes an output 125 connected to the antenna terminal 109 via a discrete phase shifter 127.

As is illustrated in FIG. 1, the transmit filter assembly 111, the receive filter assembly 119 and the discrete phase shifter 127 are electronical circuits arranged separately from one another, wherein these elements in turn can be formed as microelectronic circuits, such as, for example, as chips. The substrate 101 in this case is a carrier layer for the individual chips. In particular, the discrete phase shifter 127 is formed using discrete circuit elements, such as, for example, capacitors, inductivities or resistors. The discrete phase shifter 127 can thus be formed as a separate circuit, such as, for example, a semiconductor chip.

As it has already been mentioned, the discrete phase shifter serves to set a predetermined phase shift between its input and its output so that the receive filter assembly 119 is decoupled from the transmit filter assembly 111. Preferably, the discrete phase shifter 127 is formed as a 90° phase shifter to set a 90° phase shift as the predetermined phase shift. Since the discrete phase shifter 127 is formed of discrete circuit elements, it is possible to set any phase shift, which is, for example, a multiple of 90°.

Since according to the invention the transmit filter assembly 111, the receive filter assembly 119 and the discrete phase shifter 127 are arranged separately from one another, it is possible according to the invention to associate a separate ground level which is, for example, arranged below the respective substrate portion, to each of the chips. The first substrate portion 103, for example, comprises a first ground level associated to the transmit filter assembly 111. In analogy, the second substrate portion 105 includes a second ground level associated to the receive filter assembly 119, the first ground level and the second ground level preferably being spaced apart from each other.

According to an aspect of the present invention, the third substrate portion 107 includes a third ground level associated to the discrete phase shifter. Preferably, the third ground level is spaced apart from the first ground level and/or from the second ground level.

According to another aspect of the present invention, the first, second and third ground levels can be contiguous and form a continuous ground level.

According to the invention, the transmit filter assembly 111 and the receive filter assembly 119 can be employed with any frequency ranges which may be equal. The frequency ranges, however, may also be different. The frequency response of the transmit filter assembly 111, for example, includes a first center frequency and the receive filter assembly 119 includes a second center frequency, the first center frequency differing from the second center frequency. The first center frequency and the second center frequency are, for example, in a frequency range between 1 and 6 GHz. The first center frequency is, for example, in a range up to 2 GHz and the second center frequency is in a range between 2 and 3 GHz.

According to another aspect, the present invention provides a method for manufacturing a transmit/receive filter where at first a substrate is provided. In another method step, a transmit filter assembly is provided and a receive filter assembly is also provided. Additionally, a discrete phase shifter is provided and an antenna terminal is formed or provided. The transmit filter assembly is arranged on a first substrate portion, the receive filter assembly is arranged on a second substrate portion and the discrete phase shifter is arranged on a third substrate portion. In another method step, an output of the transmit filter assembly is connected to the antenna terminal and an input of the receive filter assembly is connected to the antenna terminal via the discrete phase shifter to decouple the receive filter assembly from the transmit filter assembly.

Preferably, the inventive transmit/receive filter is accommodated in a package, such as, for example, in a P-TSLP package. The technology used when manufacturing the P-TSLP package allows free design of the mounting islands for the chips. According to another aspect of the present invention, structures corresponding to conductive tracks and being used for this can be formed. Boundaries result from the structural precision of the conductive tracks. The preferred conductive track material is nickel provided with a gold coating. As has already been mentioned, the inventive assembly has a good Rth and a good heat coupling to the mounting substrate compared to conventional ceramic setups or conventional lead frame-based packages.

The filter chips illustrated in FIG. 1, i.e. the transmit filter assembly 111 and the receive filter assembly 119, each have a size of 1 mm². Since the relative dielectric constant of conventional substrates is about 4, the majority of the carrier material, according to the prior art, would be required to accommodate the conductor structures. According to the invention, passive structures are for example formed on an additional chip, such as, for example, silicon, which has a higher relative dielectric constant. A smaller construction can thus be obtained according to the invention. Supporting this, capacitors and other elements can for example be placed on this additional chip, such as, for example, the third substrate portion 107, together with the discrete phase shifter 127. If, for example, the inventive transmit/receive filter structure is accommodated in a TSLP package having an additional chip, the area required for this will be about A=3.8×2.5 mm².

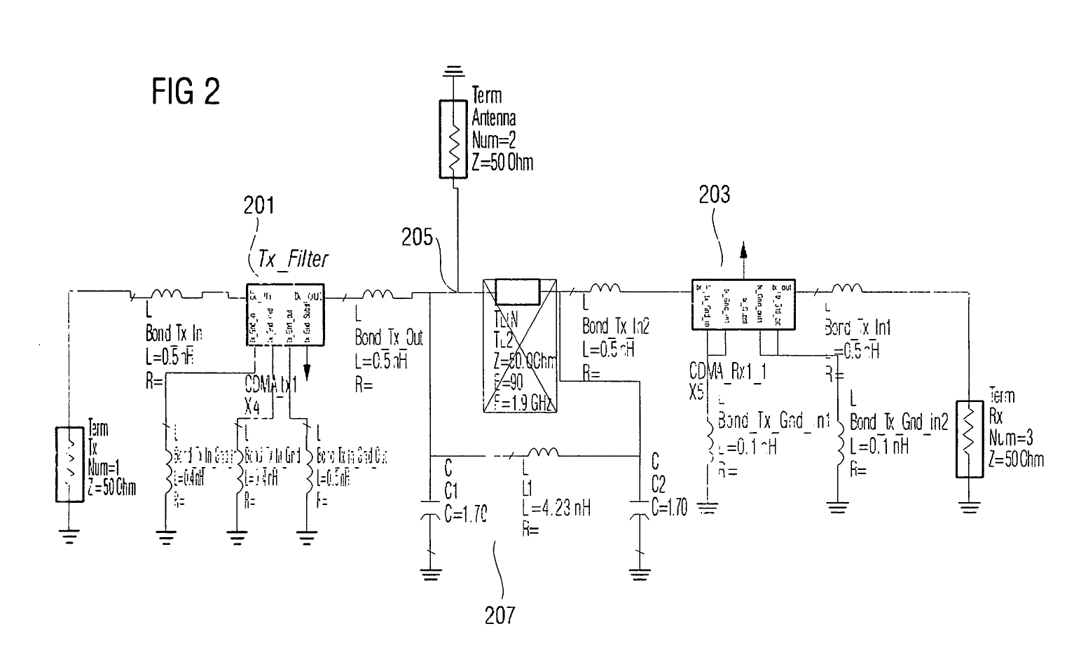

FIG. 2 shows a basic setup of the inventive transmit/receive filter.

The transmit/receive filter includes a transmit filter assembly 201 (Tx_filter), a receive filter assembly 203, an antenna terminal 205 and a discrete phase shifter 207.

The transmit/receive filter illustrated in FIG. 2 is formed to transmit and receive CDMA signals (CDMA=code division multiplex access). The transmit filter assembly 201 is coupled to ground via an inductivity and via a resistor representing the transmitter. The transmitter filter assembly additionally comprises a plurality of terminals each coupled to ground via an inductivity. An output of the transmit filter assembly 201 is coupled to the antenna terminal 205 via an inductivity. The antenna terminal is coupled to ground via a resistor representing the antenna.

An input of the receive filter assembly is coupled to ground via an inductivity and via a resistor representing the receiver. Additionally, the receive filter assembly 203 includes a plurality of further terminals each coupled to ground via an inductivity.

An output of the receive filter assembly 203 is connected to the antenna terminal 205 via the discrete phase shifter 207. The discrete phase shifter 207 includes an inductivity, both terminals of which are each coupled to ground via a capacity. Some values for the discrete resistors, capacities and inductivities are also indicated in FIG. 2.

The block circuit diagram of the inventive transmit/receive filter illustrated in FIG. 2 has been used to determine a performance of the inventive transmit/receive filter.

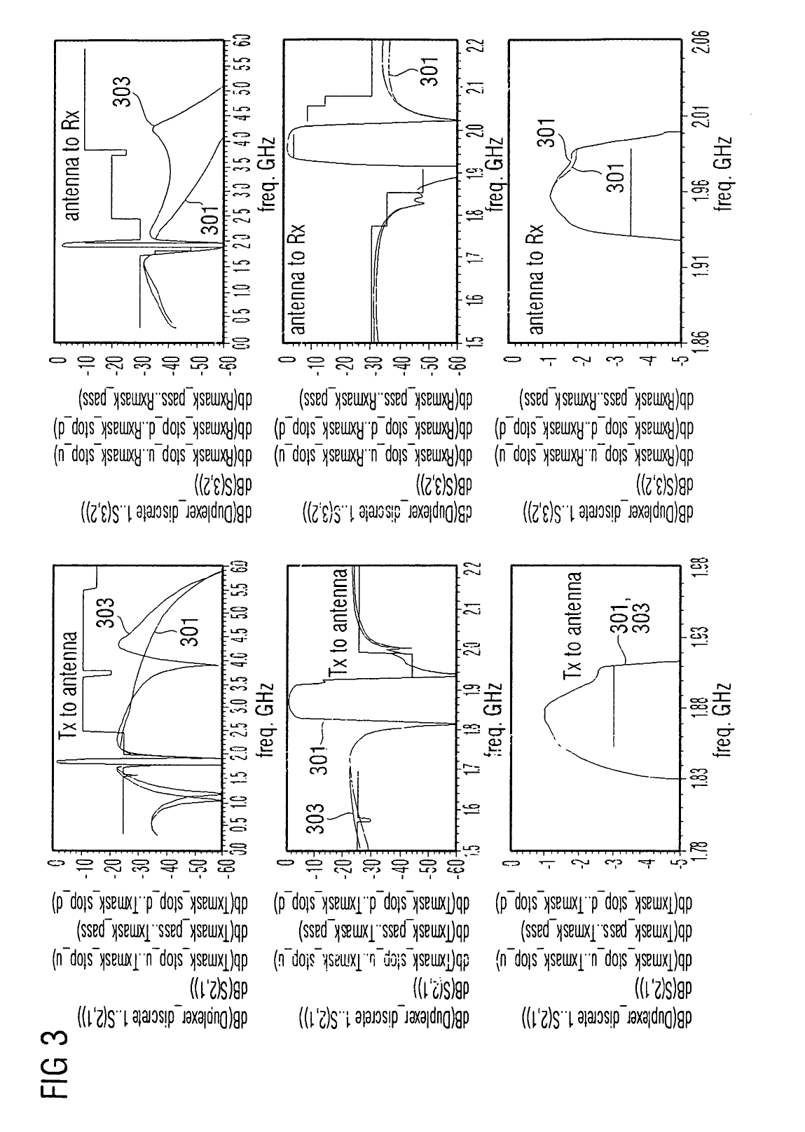

In FIG. 3, the performance of the inventive transmit/receive filter having the discrete phase shifter is shown in comparison to a prior art assembly using a conventional λ/4 transformer. Here, the inventive graph is indicated by 301, the prior art graph is indicated by 303.

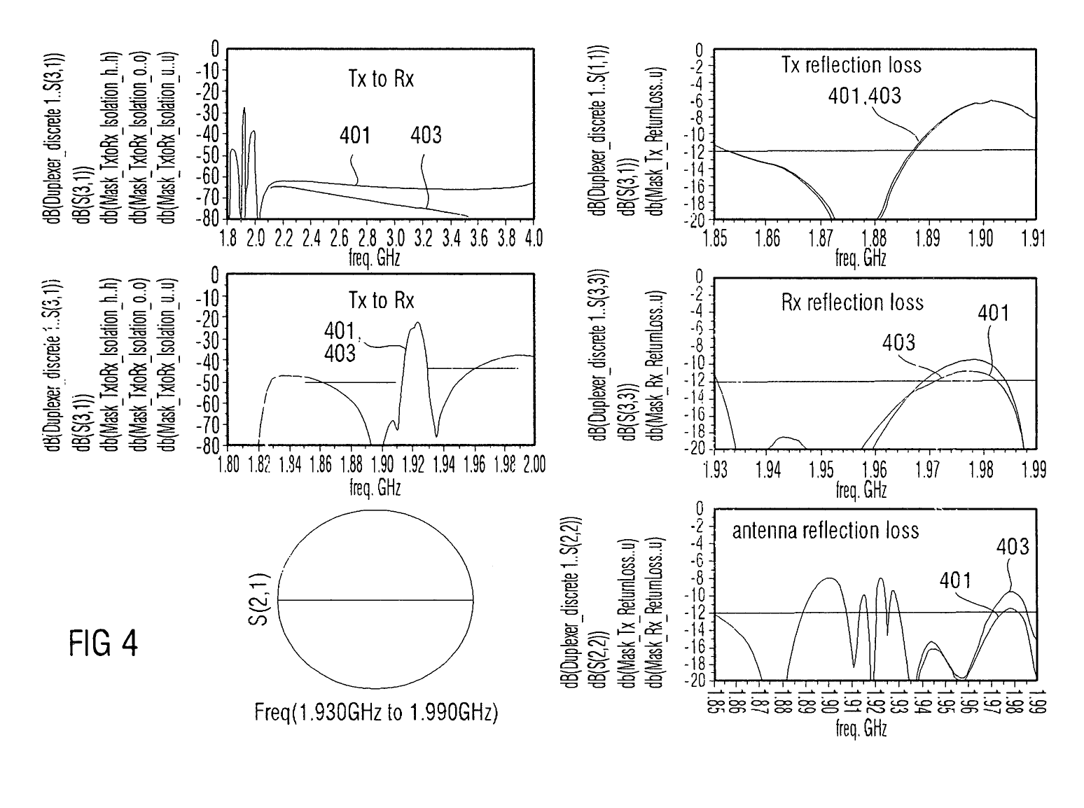

In FIG. 4, further embodiments for a performance of the inventive transmit/receive filter, compared to the prior art approach are illustrated. Here, the inventive graphs are indicated by 401 and the prior art graphs are indicated by 403.

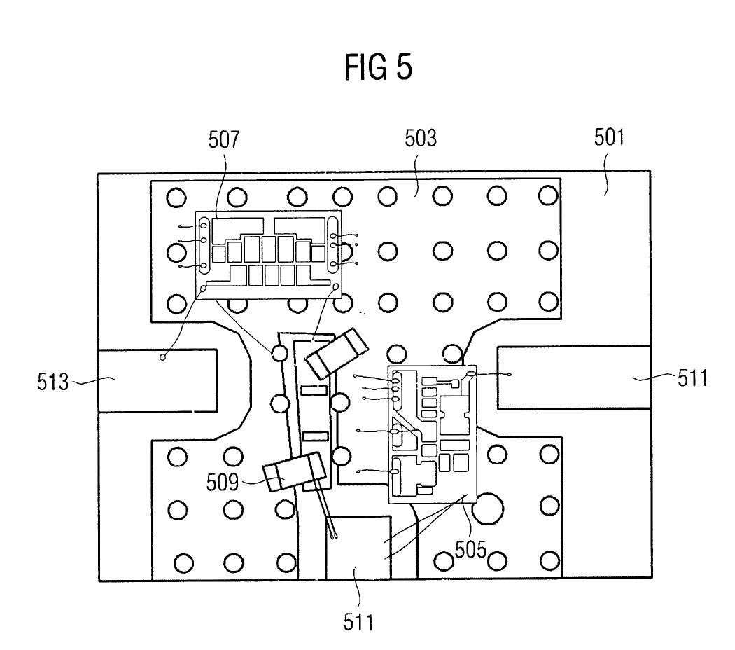

In FIG. 5, a measurement setup for measuring the inventive transmit/receive filter is illustrated.

A mounting level 503 is arranged on a substrate 101, a transmit filter assembly 505, a receive filter assembly 507 and a discrete phase shifter 509 being arranged on this level. Additionally, an antenna terminal 511 is formed on the substrate. An input of the transmit filter assembly 505 (transmit filter) is connected to a terminal 511 via wires. In analogy, an output of the receive filter assembly 507 is coupled to a terminal 513 via a connecting wire, such as, for example, via a bond wire. Additionally, the antenna terminal 511 is coupled to an input of the receive filter assembly 507 via the discrete phase shifter 509, wherein connecting wires are used here to form an electrical connection.

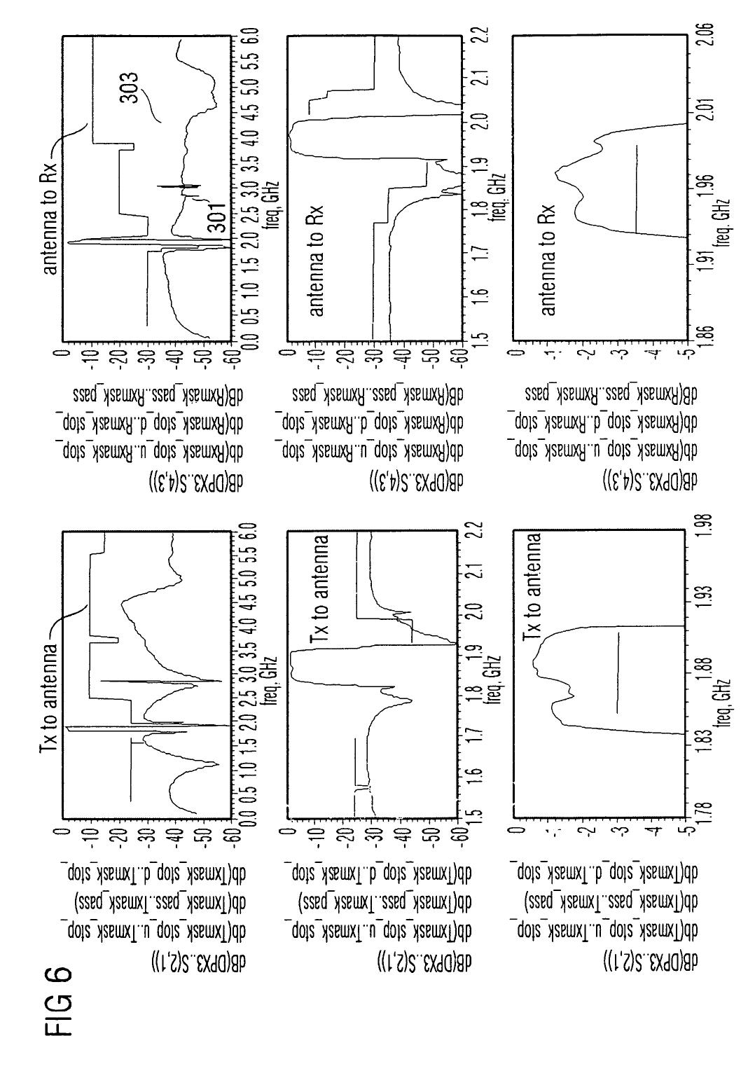

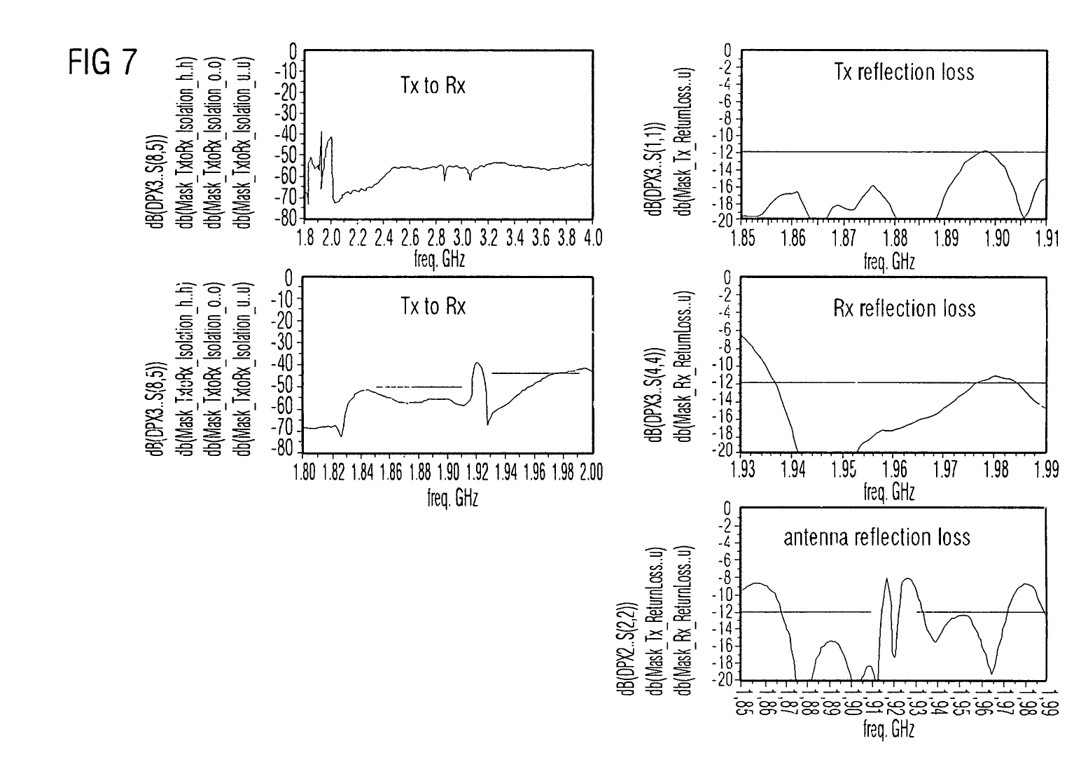

FIGS. 6 and 7 illustrate some measuring results.

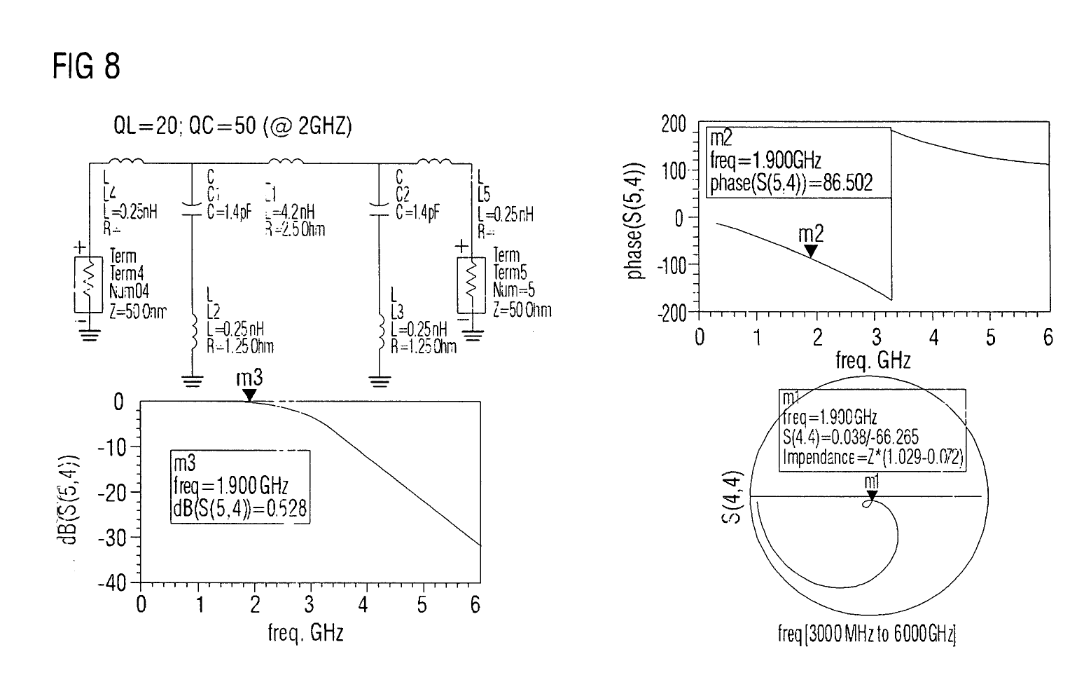

FIG. 8 shows another embodiment of an inventive discrete phase shifter. The discrete phase shifter includes three inductivities connected in series, wherein one end of the series connection formed in this way is coupled to ground via a resistor and another end of the series circuit formed in this way is coupled to ground via a resistor. Between two respective inductivities, there is a terminal coupled to ground via a series connection including a capacity and an inductivity. Furthermore, some exemplary values for the discrete elements are indicated in FIG. 8 for a frequency range around 2 GHz.

The inductivities, for example, comprise a quality Q_{L}=20. The capacities, for example, comprise a quality Q_{C}=50.

Additionally, some losses of the inventive discrete phase shifter are indicated in FIG. 8. It is obvious that the inventive discrete phase shifter has very small insertion losses. In comparison, it is to be pointed out that a prior art λ/4 transformer having a BT laminate has insertion losses of 0.5 dB. It is also to be mentioned here that a Q of 13 is realistic for a 2×2.5 μm conductor. Four metallization layers, each having a size of 4×2.5 μm, are required for this reason to obtain Q values of >25. The inventive concept allows a reduction of the manufacturing complexity and an increase in the Qs required.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A transmit/receive filter comprising:
an antenna terminal;
a transmit filter assembly arranged on a first substrate portion, an output of the transmit filter assembly being connected to the antenna terminal;
a receive filter assembly arranged on a second substrate portion; and
a discrete phase shifter arranged on a third substrate portion, the discrete phase shifter being formed of discrete circuit elements and an input of the receive filter assembly being connected to the antenna terminal via the discrete phase shifter, the discrete phase shifter operable to set a predetermined phase relation to decouple the receive filter assembly from the transmit filter assembly.

2. The transmit/receive filter according to claim 1, wherein the substrate is a single-layered substrate.

3. The transmit/receive filter according to claim 1, wherein the first substrate portion, the second substrate portion and the third substrate portion are spaced apart from one another.

4. The transmit/receive filter according to claim 1, wherein the first substrate portion comprises a first ground level associated to the transmit filter assembly, and wherein the second substrate portion comprises a second ground level associated to the receive filter assembly, the first ground level being spaced apart from the second ground level.

5. The transmit/receive filter according to claim 4, wherein the third substrate portion comprises a third ground level associated to the discrete phase shifter, wherein the third ground level is spaced apart from the first ground level or from the second ground level.

6. The transmit/receive filter according to claim 1, wherein the discrete phase shifter is a 90° phase shifter.

7. The transmit/receive filter according to claim 1, wherein the discrete circuit elements comprise elements selected from the group consisting of discrete resistors, discrete capacities and discrete inductivities.

8. The transmit/receive filter according to claim 1, wherein a frequency response of the transmit filter assembly comprises a first center frequency, wherein a frequency response of the receive filter assembly comprises a second center frequency, the first center frequency differing from the second center frequency.

9. The transmit/receive filter according to claim 8, wherein the first center frequency and the second center frequency are in a range between 1 GHz and 6 GHz.

10. A method for manufacturing a transmit/receive filter, comprising the steps of:
providing a transmit filter assembly;
providing a receive filter assembly;
providing a discrete phase shifter;
providing an antenna terminal;
arranging the transmit filter assembly on a first substrate portion;
arranging the receive filter assembly on a second substrate portion;
arranging the discrete phase shifter on a third substrate portion;
connecting an output of the transmit filter assembly to the antenna terminal; and
connecting an input of the receive filter assembly to the antenna terminal via the discrete phase shifter, the discrete phase shifter operable to decouple the receive filter assembly from the transmit filter assembly.

11. The method of claim 10 wherein the discrete phase shifter includes a phase shifter input and a phase shifter output, and the discrete phase shifter is operable to set a predetermined phase shift between the phase shifter input and the phase shifter output to decouple the receive filter assembly from the transmit filter assembly.

12. A method of decoupling a receiver filter assembly from a transmit filter assembly, the method comprising:
a) providing an antenna terminal;
b) providing a transmit filter assembly arranged on a first substrate portion, an output of the transmit filter assembly being connected to the antenna terminal;
c) providing a receive filter assembly arranged on a second substrate portion;
d) providing a discrete phase shifter arranged on a third substrate portion, the discrete phase shifter including a phase shifter input and a phase shifter output; and
e) setting a predetermined phase shift between the phase shifter input and the phase shifter output and thereby decoupling the receive filter assembly from the transmit filter assembly.

13. The method of claim 12 wherein the predetermined phase shift is a 90° phase shift.

14. The method of claim 12 wherein the predetermined phase shift is a multiple of 90°.

15. The method of claim 12 wherein the substrate is a single-layered substrate.

16. The method of claim 12 wherein the first substrate portion, the second substrate portion and the third substrate portion are spaced apart from one another.

17. The method of claim 12 wherein the first substrate portion, the second substrate portion and the third substrate portion are portions of a continuous substrate or of a continuous substrate layer.

18. The method of claim 12 wherein a frequency response of the transmit filter assembly comprises a first center frequency, and wherein a frequency response of the receive filter assembly comprises a second center frequency, the first center frequency differing from the second center frequency.

19. The method of claim 18 wherein the first center frequency and the second center frequency are in a range between 1 GHz and 6 GHz.

20. The method of claim 1 wherein the transmit/receive filter is provided on a P-TSLP package.
